(19) United States
(12) Patent Application Publication
(10) Pub. No.: US 2005/0138443 A1
(43) Pub. Date: Jun. 23, 2005

(54) Method for C state management

(76) Inventor: Barnes Cooper, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,321

(22) Filed: Dec. 23, 2003

(51) Int. Cl. G06F 1/26

(52) U.S. Cl. 713/300

(57) ABSTRACT

A method for entering a particular C state to save power based on bus master activities. The current method is only applied when the current C state has been promoted to C3 and bus master activity has been detected since the last time BM_STS was sampled. The C3 target state is overridden by the C2 state anytime bus master traffic has occurred since the last time BM_STS was read and cleared. The OS reads the status bit on every idle entry where the target is C3. If the BM_STS is set, the idle handler clears it and enters the C2 state. If the BM_STS bit is clear, the idle handler enters C3. The difference being that the handler will enter C2 only for one instance, but will still keep the target C state set to C3.

### BACKGROUND INFORMATION

Current mainstream operating systems such as Windows 2000 and Windows XP use a C state algorithm as recommended by the ACPI 1.0b specification. In this algorithm, the OS monitors the processor idleness by taking timestamps when the processor goes idle (no threads in the running or ready-to-run state), and taking another timestamp when the processor becomes busy. By accumulating the deltas between timestamps across larger time intervals, the idleness of the processor can be calculated as the ratio of idle time divided by sampling interval. On each entry into the idle loop, the OS enters a C state numbered C1, C2, C3 in order to save power. Lower numbered C states have lower latency to enter/exit, but consume more power than higher numbered C states. The OS employs a conservative algorithm to cycle through C states starting with the lowest latency, highest power C1 state when the processor has just become idle or is exhibiting relatively high utilization, in order to affect performance as little as possible. As the processor becomes more idle for another sampling interval, the OS may decide to promote to a higher C state, and the process repeats, moving to higher or lower numbered C states depending on idleness. In an idle system, it is quite common that the processor spends 99% of the time in the C3 state.

C3 is defined as a non-snoopable state. This means that the processor is unable to detect cache snoops while the processor is placed in C3. The OS is responsible for detecting bus master traffic through the ACPI defined bus master status bit, and disabling bus master traffic through the bus master arbiter disable bit before entering a C3 state. The general idea is to avoid entering the C3 state whenever there is bus master traffic occurring, because the long latency to exit C3 with snoop traffic blocked can cause bus master overruns and underruns, depending upon the device characteristics and buffer capabilities. Unfortunately, the current bus master avoidance policy incorporated into the OS is inefficient in the presence of bus mastering devices. Thus an improved C state policy handler that resolves the problems associated with currently implemented algorithms is needed.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a flowchart of an improved C state policy handler.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

A method is described for entering a particular C state to save power based on bus master activities. The OS monitors processor idleness by taking timestamps of when the processor goes idle and taking another timestamp when the processor becomes busy. By accumulating deltas between the timestamps, the idleness of the processor can be calculated. On each entry into the idle loop, the OS enters a C state numbered C1, C2, C3 in order to save power. The OS may decide to move to higher or lower numbered C states depending on idleness.

Since the C3 state is a non-snoopable state, the OS is responsible for detecting bus master traffic through ACPI's bus mater status bit (BM_STS). Currently, the OS takes an instantaneous sample of bus master activity, just prior to attempting an entry into C3. Since the bus master status bit is sticky, the OS takes an instantaneous sample by clearing the BM_STS bit and immediately reading the bit back. If the BM_STS comes back clear, this implies that no bus master activity is occurring at this instant in time, and the OS will decide to enter C3. If the bit comes back set, this implies that bus master activity is occurring at this instant in time, and the OS demotes to C2.

By contrast, the present algorithm handles processor utilization by determining Idle% parameter and is not affected by BM_STS. Idle % is the percentage of time a processor has been idle across the last sampling interval. The present algorithm makes better sense as bus master traffic is not an indicator of processor utilization, and thus should not affect the target C state which is set through a promotion/demotion scheme based on processor utilization.

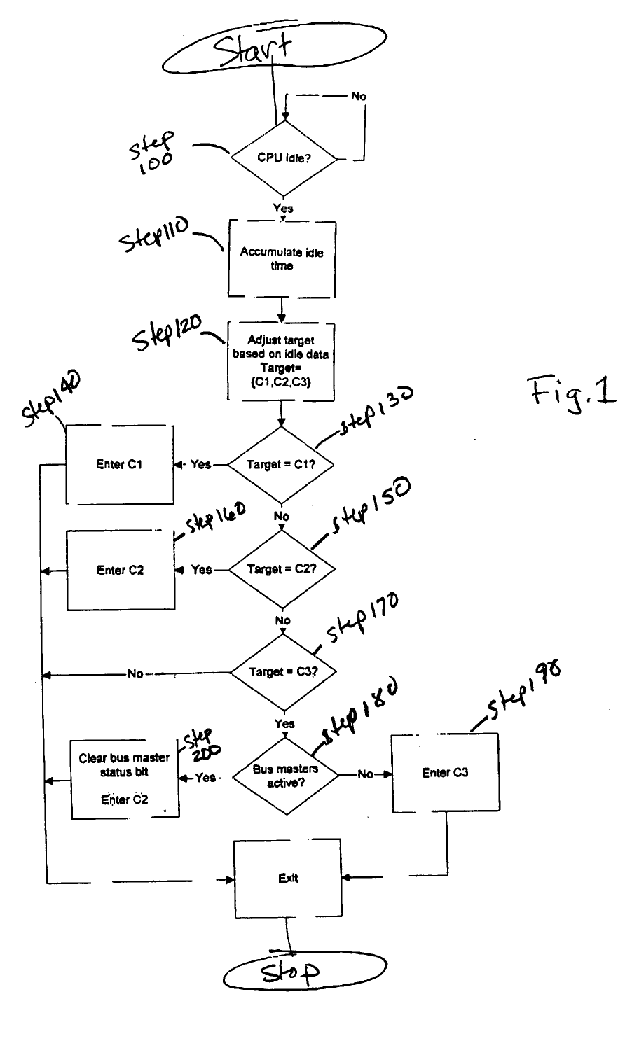

The current sampling policy is used only when the current C state has been promoted to C3 and bus master activity has been detected since the last time BM_STS has been sampled. The C3 target state is overridden by the C2 state anytime bus master traffic has occurred since the last time BM_STS has been read and cleared. Instead of taking an instantaneous sample of bus master activity, the new algorithm uses the sticky nature of the BM_STS bit and reads it on every idle entry where the target is C3. If the BM_STS is set, the idle handler clears it and enters the C2 state. If the BM_STS bit is clear, the idle handler enters C3. The difference being that the handler will enter C2 only for one instance, but will still keep the target C state set to C3. FIG. 1 illustrates this new method in more detail.

FIG. 1 is a flowchart of an improved C state policy handler. Initially, at step 100, the OS determines if the CPU is idle. If the CPU is not idle, the OS will keep checking its status. However, if the CPU is idle, then at step 110, the OS will accumulate the CPU's idle time as previously described. Next, the OS will determine the target state based on the CPU's idle time (step 120). If the idle time is within the C1 target state (step 130), the system will enter Cl state (step 140). If the idle time is not in the target C1 state, then the system will determine if the idle time is in the target C2 state (step 150). If the idle time is within the C2 target state, the system will enter C2 state at step 160. If the system is not in the C2 state, then the OS will determine if the target time is in the C3 state at step 170. If is not in the C3 state, the system will exit.

If the target state is C3, the OS will determine if the bus master is still active at step 180. The OS will determine if the bus master is active by reading the bus master status bit on every idle entry where the target is C3. If the BM_STS bit is clear, the idle handler enters C3 at step 190. However, If the BM_STS is set, the idle handler clears it (step 200) and enters the C2 state (step 160). The handler will enter C2 only for one instance, but will still keep the target C state set to C3. The following examples illustrates the new algorithm.

As a first example, suppose there is a persistent bus mastering device that accesses memory every 1 ms for a short period of time. With the new algorithm, the processor will wake up from C3 on the first bus master event, the idle handler will be re-entered (bus master traffic has ceased), the handler will sample BM_STS and see that bus master traffic has occurred since the last time it was read, the handler will clear it, and enter the C2 state. In this case, the target state is still C3 (C3 will be immediately re-entered once the bus master stops), but the processor is able to remain in a snoopable state and sleep for longer intervals without waking up. Additionally, the bus mastering device does not see excessive delay to main memory. After the first occurrence, the algorithm effectively detects the bus master traffic pattern and remains in the C2 state until the bus master traffic ceases. This policy dramatically improves the C state policy handling in the presence of bus mastering devices

In a second example, consider an intermittent bus mastering device that transfers a significant amount of data every 1 ms. In this case, the new algorithm will wake up from C3, sample BM_STS and detect that bus master traffic is occurring, and enter the C2 state. While in the C2 state, the bus mastering device runs unimpeded to main memory, and after the second exit from the C2 state, the processor will quickly re-enter the C3 state, rather than wait for a complete promotion interval. As a result of this change, the processor will spend a large amount of time in the C3 state whereas with the current algorithm the processor would remain entirely within C2.

A final example is where a device transfers burst like traffic periodically. In this case, the algorithm would avoid re-entering C3 state. As the periodic transfer initiates, the processor will exit C3, sample BM_STS and detect bus master traffic, and enter the C2 state. Again, after one more exit from C2, the processor will re-enter C3. This is also a significant improvement over the existing algorithm by avoiding C3 in a consistent fashion (only one latency event seen by device) only when absolutely necessary.

Advantageously, the present algorithm improves C3 utilization (better battery life) and reduces bus master stress (delay to main memory), without affecting processor performance. The algorithm accomplishes this with the new sampling policy for BM_STS, and thus effectively decouples bus master traffic from the promotion/demotion scheme, which is now entirely based on processor idleness.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A method of transitioning a processor to a low power state comprising the steps of:
determining idle time of the processor;
setting the processor to a third low power state based on the idle time;
determining if bus master is active;
if active, transitioning the processor to a second low power state.

2. The method of claim 1, wherein the step of transitioning the processor to a second low power state occurs for only one instance.

3. The method of claim 2, wherein the processor is still set to the third low power state.

4. The method of claim 1, wherein the step of determining if bus master is active further comprising reading a bus master status bit on every idle entry when the processor is in the third low power state.

5. The method of claim 4, wherein if the status bit is clear, entering the third low power state.

6. The method of claim 5, wherein if the status bit is set, entering the second low power state.

7. The method of claim 1, wherein the processor transitions to the second low power state from the third low power state when there has been bus master activity detected since last sampling of a bus master status bit.

8. The method of claim 7, wherein the third low power state is overridden by the second low power state anytime activity has been detected since last reading and clearing of the status bit.
